(19) United States
(12) Patent Application Publication
(10) Pub. No.: US 2010/0134523 A1
(43) Pub. Date: Jun. 3, 2010

(54) SEQUENTIAL COLOUR MATRIX DISPLAY AND ADDRESSING METHOD

(75) Inventors: Hugues Lebrun, Coublevie (FR); Thierry Kretz, Saint Jean de Moirans (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Thales, Neuilly-Sur-Seine (FR)

(21) Appl. No.: 12/063,359

(22) PCT Filed: Aug. 9, 2006
(86) PCT No.: PCT/EP06/65184

§ 371 Date: Aug. 4, 2008

(30) Foreign Application Priority Data
Aug. 12, 2005 (FR) 05 08543

(51) Int. Cl. G06F 3/038; G09G 5/10

(52) U.S. Cl. 345/690; 345/214

(57) ABSTRACT

A matrix display with a progressive color display, of active matrix-type, includes pixels arranged according to N rows and m columns. The N rows of the display are distributed into n groups, and each pixel column includes n column conductors, allowing for a write-selection of pixels of n rows in parallel, one row per group.

This invention relates to a matrix display with sequential display of colours. It relates in particular to LCDs (Liquid Crystal Display).

These matrix displays are of the active matrix type. They include an active element for each pixel, which is controlled appropriately to display a grey level corresponding to a Red, Green or Blue luminance. Contrary to displays on which the colour image is formed using a colour filter structure per pixel, sequential colour displays use a red, green and blue sequential lighting, associated with a video addressing process using coloured sub-frame in each frame. On each frame, a red image, a green image and a blue image are sequentially displayed. In other words, in the traditional operating mode of a display, the colour is formed by spatial modulation of the light while with an operating mode with sequential colour display, the latter is restored via a temporal modulation of light.

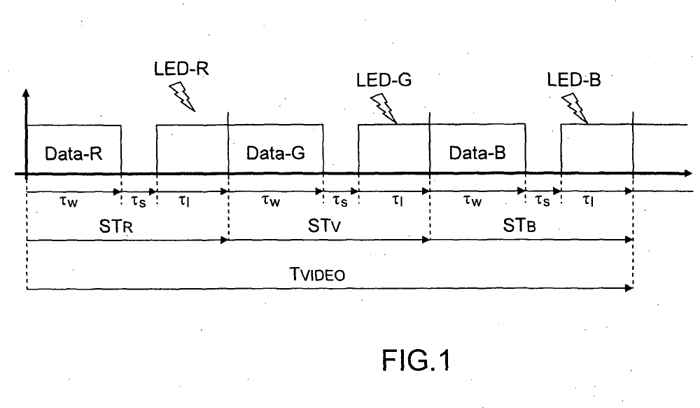

A known addressing method of a monochrome matrix display in sequential liquid crystal colour is illustrated in FIG. 1. A T_{VIDEO} image frame is thus comprised of three coloured sub-frames: a red sub-frame SF_{R}, a green sub-frame SF_{G} and a blue sub-frame pixel SF_{B}.

Each sub-frame includes three phases: a write phase τ_{w}, during which the data corresponding to the luminance is applied to each active element, a stabilisation phase τₛ of the liquid crystal, then a display backlight phase τ₁, in the considered luminance.

In an embodiment of the display backlight, the light source includes red, green and blue light-emitting diodes (LEDs) sequentially in lit turn.

With overhead projectors or video projectors, the most commonly used system is a segmented colour wheel positioned between the LCD display plane and the projection plane. The backlighting source is in this case a white light source.

The duration of the three coloured sub-frames must be less than the duration of a video frame, typically 20 milliseconds for operation at 50 Hz or 16.7 milliseconds for operation at 60 Hz. The write phase is performed line by line, such a solution can be implemented only with displays that have few lines, in such a way that the write phase τ_{w} in sequence for each of the lines in the display can take place, in each sub-frame, in a limited amount of time of about 2 milliseconds.

For example, let's take a 200 line display. The following durations are obtained with current technologies: about 2 milliseconds for the write phase τ_{w}, 1 millisecond for the stabilisation phase τₛ and 3 milliseconds for the backlight phase τₑ. This gives a total of 18 milliseconds for each frame, which is entirely compatible with the duration of a video frame, which is typically 20 milliseconds at 50 Hz.

This typically corresponds to applications using small screens.

Beyond this, it is no longer possible to address the display in this way with three coloured sub-frames per line.

For applications using VGA-format displays (640×480) or a larger format, i.e. displays with 600 lines or more, another solution must therefore be considered.

A problem which thus occurs in the invention is to be able to address colour displays of great complexity in sequential colour mode.

The purpose of the invention is therefore a matrix display with sequential colour display and a corresponding addressing method.

According to the invention, the rows of pixels on the display are distributed into n≧2 groups of rows. It is then possible to address in parallel n matrix pixel rows, either via the same row selection line control circuit, or by separate line control circuits, but synchronised. Alternatively, the separate line control circuits may not be synchronous.

To each pixel column is associated a column conductor by group, driven by the column control circuit (column driver) in order to apply to it the video data to be displayed. If there are n groups of rows, all of the pixels of n rows can be written at the same time in parallel. At the first order, the write time for an N-row display, becomes that of a N/n-row display.

According to an aspect of the invention, the groups are formed in such a way that the N/n rows of a group are N/n successive rows of the matrix. Each group is therefore a display band which includes N/n successive rows from rank 1 to N/n. The n rows selected in parallel are then the rows with the same rank in each group.

According to another aspect of the invention, the groups of rows are formed in such a way that the n rows selected at the same time are n successive rows of the matrix. The groups of rows are then imbricated.

A row selection line control circuit capable of addressing a display according the invention makes it possible to select n rows of the matrix in parallel, at each write phase.

A column control circuit capable of controlling the display of the data on a display according to the invention, is such that it makes it possible to apply the video data over n column conductors by pixel column in the display, so as to make possible the writing in each pixel column of the display, of the pixels that belong to the n rows selected in parallel.

In an embodiment of the invention, as many column conductors as there are groups of pixel rows are provided with for each pixel column in the matrix.

The column conductors can be positioned differently according to whether they are controlled by the same column control circuit or different circuits but all located on the same side of the matrix, or by column control circuits located on either side of the matrix, with the latter solution applied more particularly when the matrix is divided into two bands of successive rows according to the invention.

The invention therefore relates to a matrix display with sequential colour display, of the active matrix type, comprising pixels arranged according to N rows and m columns, characterised in that the N rows are divided into n groups, and in that each pixel column includes n column conductors, making possible a selection for writing of pixels of n rows in parallel, one row per group.

The invention also relates to a method for addressing a matrix display, of the active matrix type, in a sequential colour display mode, said display including pixels arranged in matrix format into rows and columns, characterised in that it consists in selecting n pixel rows in parallel, and in applying the video data corresponding to said n rows using n column conductors for each pixel column, each one of the n conductors providing a piece of video data to a pixel of one of the n rows.

Other advantages and characteristics of the invention shall appear more clearly as the following description is read, issued as an example and not as a limitation of the invention and in reference to the annexed drawings, in which:

FIG. 1 illustrates a sequential colour display mode of an LCD display;

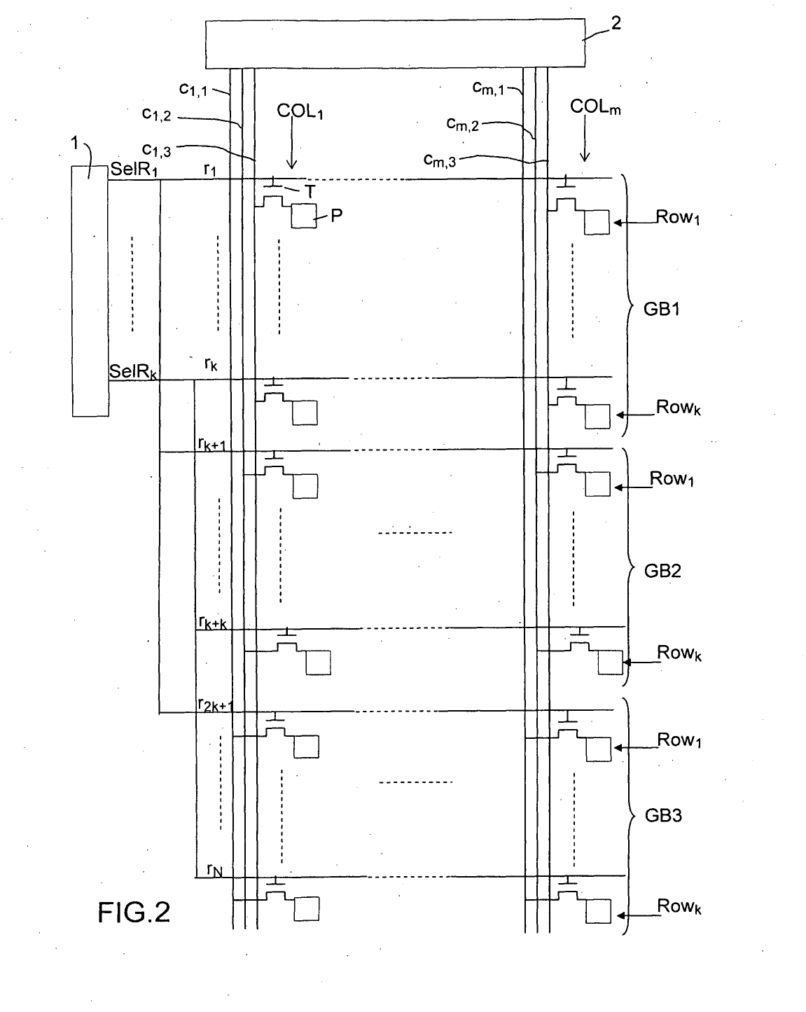

FIG. 2 illustrates an example of line arrangement on a matrix display according to the invention;

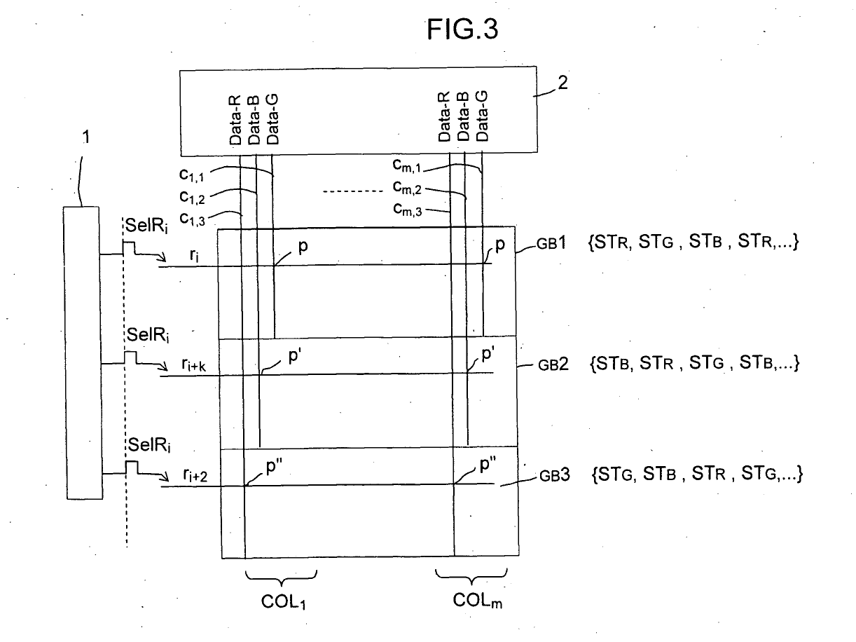

FIG. 3 illustrates a corresponding addressing device, coupled with colour sequencing according to an aspect of the invention;

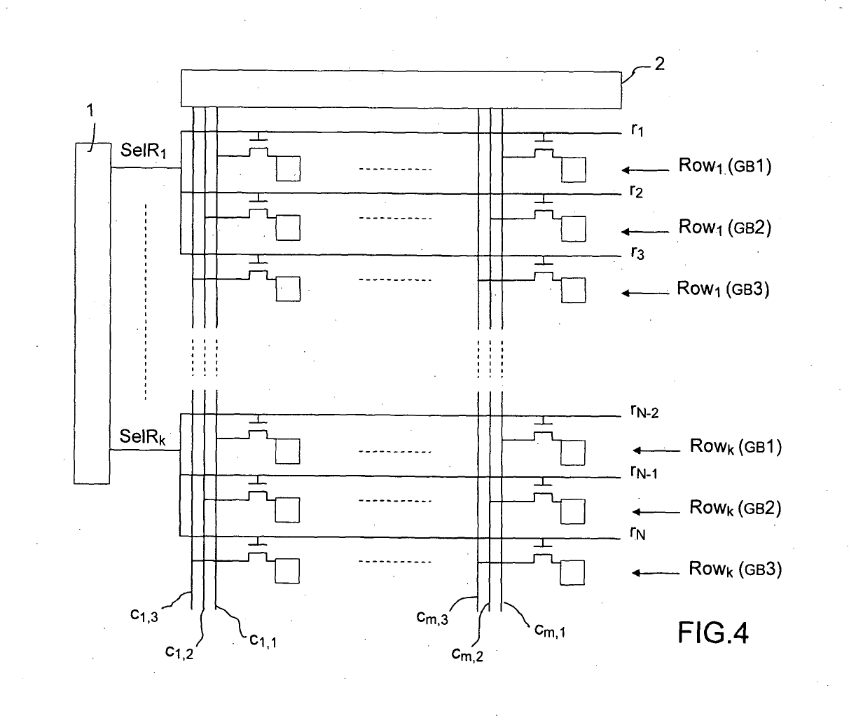

FIG. 4 is another example of arranging the lines of a matrix display according to the invention;

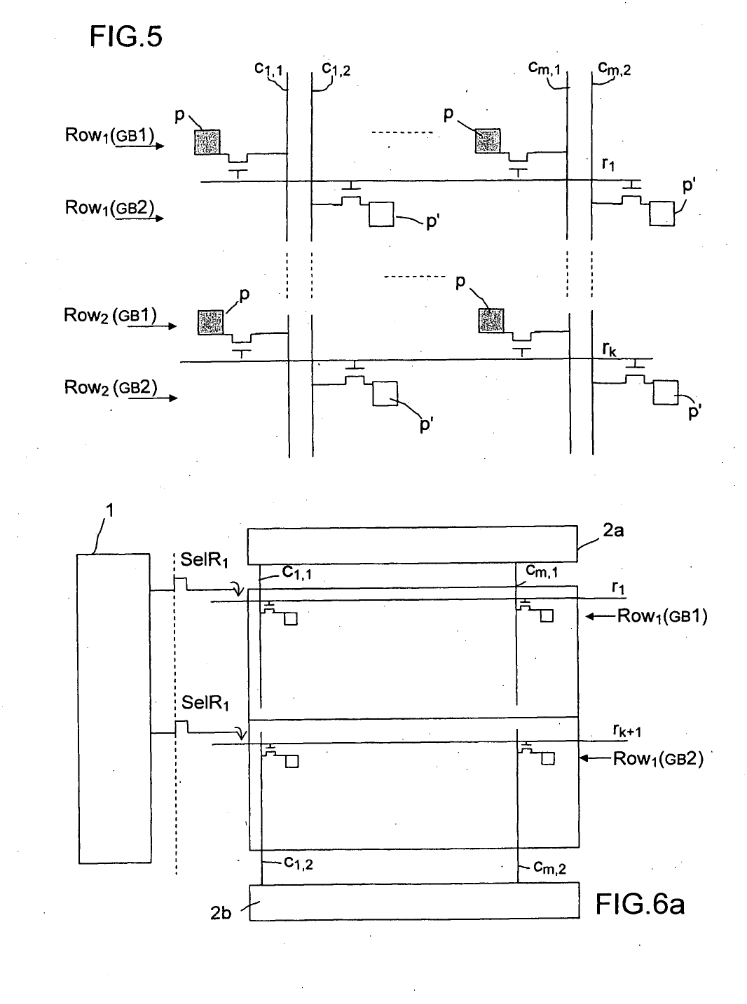

FIG. 5 is an alternative to the arrangement in FIG. 4, for n=2 groups, which makes possible a simplification in matrix realisation;

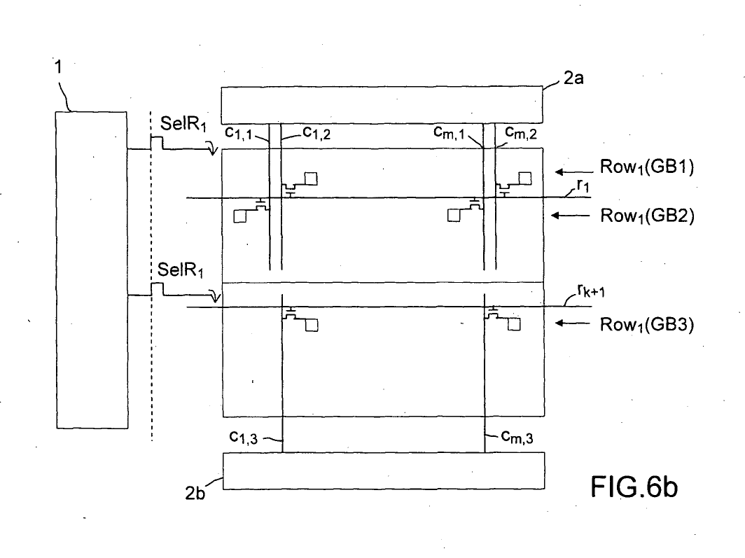

FIGS. 6a and 6b illustrate another example of arranging the lines according to an alternative embodiment of the invention;

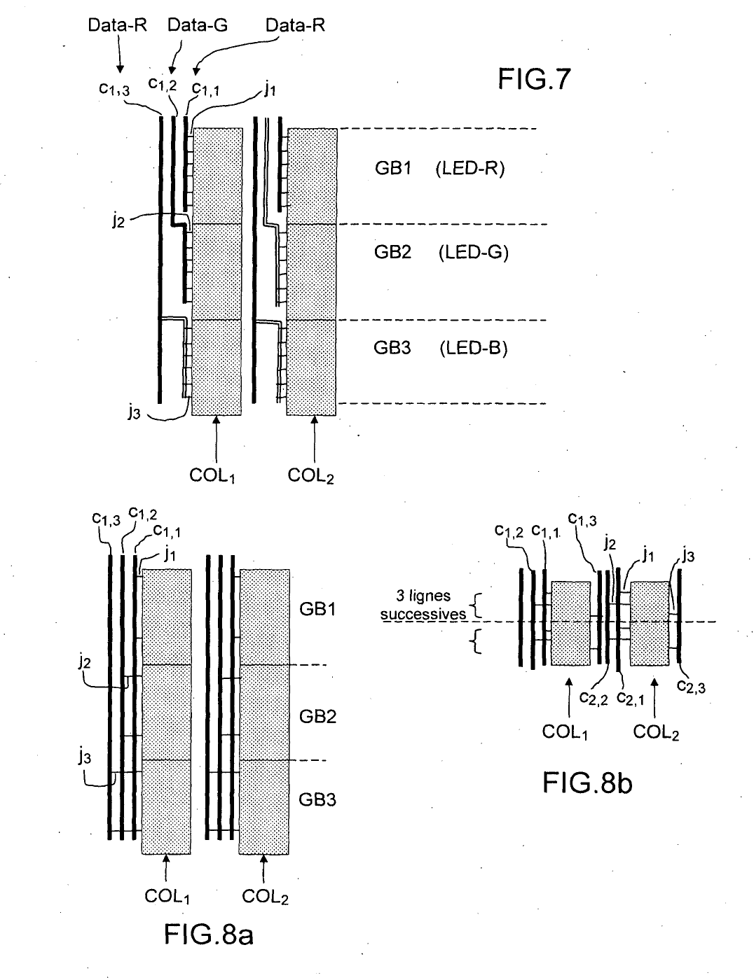

FIG. 7 is a simplified illustration of an example of topology of an active matrix of a display with an arrangement in bands according to the invention;

FIGS. 8a et 8b illustrate by way of a diagram another example of topology, for an arrangement in bands (FIG. 8a) or an arrangement in imbricated groups;

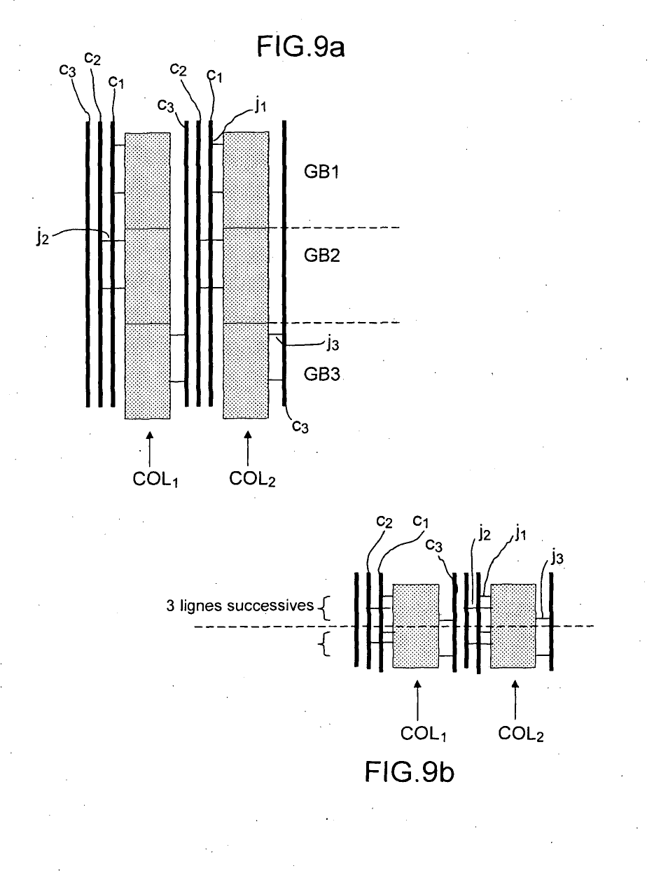

FIGS. 9a and 9b illustrate an alternative to the preceding topology.

FIG. 2 illustrates a first embodiment of a distribution of N lines of a matrix display into n groups of N/n rows according to the invention. The display is of the active matrix type: to each pixel P is associated a switching element, typically a transistor T. The transistor makes it possible to charge pixel P with voltage that is representative of a grey level to be displayed. The transistor gates for a same row are in practice all connected to the same conductor line of the active matrix, on which the line driver applies a row selection signal.

The notion of pixel row corresponds to the matrix arrangement aspect of the pixels. The notion of conducting line or row selection line corresponds to the electric control/conduction aspect. In general, this line and the gates are carried out on the active matrix by the same level conductor.

Transistor T is made active by applying a selection signal on the corresponding line of the matrix, for example r₁, and application to an associated column conductor, c_{1,3} in FIG. 2, of the voltage to be charged to the pixel.

The lines are activated sequentially by a line control circuit 1, commonly referred to as “line driver”, and the voltages are applied to the columns by a column control circuit 2, commonly referred to as “column driver”.

According to the invention, the lines are grouped together into n groups of rows.

In the embodiment represented in FIG. 2, each group includes N/n consecutive rows of the matrix, in such a way that each group represents a band of width N/n pixels of the display.

We note k=N/n

In the example n=3 (and so N=3k). There are therefore 3 groups of rows GB1, GB2, GB3, each including k consecutive rows Row₁, . . . Rowₖ from rank 1 to k. The display includes N selection lines r₁ to r_{N}. In the example, the rows of group GB1 are selected by lines r₁ to rₖ, those of group GB2 are selected by lines rₖ₊₁ to rₖ₊ₖ, and those of group GB3 are selected by lines r₂ₖ₊₁ to r_{N}.

Rows of the same rank i among k are activated at the same time by their selection signal:
their selection lines are electrically connected as represented, to receive the same selection signal: for example selection lines r₁, rₖ₊₁, and r₂ₖ₊₁ of rows Row₁ of groups GB1, GB2 and GB3 are thus electrically connected to the same output Selr₁ of the line 1 driver. The latter thus delivers k output selection signals SelR₁ to SelRₖ. Each output thus drives n=3 lines, which in practice is 3 rows of transistor gates.
or their selection lines are activated at the same time, via appropriate means (for example three synchronous line drivers, with k outputs, one driver per group).

For each column of pixels P in the display, there is a column conductor per group of k lines. In the example, with n=3, for column COL₁, there are three column conductors c_{1,1}, c_{1,2}, c_{1,3}, to control the pixels of column COL₁ belonging respectively to groups GB1, GB2, GB3. Likewise, for the last column COLₘ of the display, there are three column conductors c_{m,1}, c_{m,2}, c_{m,3}.

All of these column conductors are driven by column control circuit 2, which receives the image data to be displayed.

An addressing mode of such a display according to the invention can also be as follows, taking the case illustrated in FIG. 2, of a single line control circuit 1, providing k outputs to control the N selection lines r₁ to r_{N} of the display.

Line control circuit 1 activates a row selection signal among k at each line time. Typically, it activates the selection signal SelR₁, then the second one, . . . until the kth one.

At each line time, the column control circuit drives the n=3 times m column conductors, to apply the video data to each of the n=3 times m selected pixels.

In this addressing mode, the video data displayed on the selected pixels corresponds to the data of the current coloured sub-frame.

In an alternative addressing mode represented in FIG. 3, the displayed data does not belong to the same sub-frame from one group of rows to another. Such an addressing mode is made possible with a distribution of the rows into bands. Indeed, each band or group GB1, GB2, GB3 thus has the same width, typically a width equal to k=N/n pixels, which typically corresponds to the width of a small screen.

It is possible to design a backlight source for the display such that it includes n=3 subsets of diodes driven according to different sequences, with each subset of diodes designed to light a band of the display.

For example, a first subset of diodes is associated with the first band GB1, to light pixels p of this band, according to a first sequence: red, green, blue, red, green

A second subset of diodes is associated with the second band GB2 to light pixels p′ of this band according to a second sequence: blue, red, green, blue, red, green etc.

A third subset of diodes is associated with the third band GB3 to light pixels p″ of this band, according to a third sequence green, blue, red, green, blue, red etc.

These lighting sequences take place in parallel, synchronously.

With such a different lighting per band, the column driver must apply to each column conductor of a column of pixels, data corresponding to the specific sub-frame which varies from one column conductor to another. Taking the lighting sequences previously provided as an example, and as illustrated in FIG. 3, if we are at the first element in the sequence, the data applied to the column conductor corresponding to the first band GB1 is data Data-R of the red sub-frame, the data applied to the column conductor corresponding to the second band GB2 is data Data-B of the blue sub-frame, and the data applied to the column conductor corresponding to the third band GB3 is data Data-G of the green sub-frame.

In practice, the rows of the n bands can be driven by line control circuit 1 for the three bands as illustrated and explained in relation with FIG. 2. There can also be one line driver circuit per band. There are thus n line driver circuits, which can be integrated or external to the display, and which are controlled synchronously.

The column driver is driven so as to be able to process the three sub-frame data in parallel. For a display including m columns of pixels, it should therefore be capable to drive n=3 times m column conductors. For implementing an addressing mode such as illustrated in FIG. 3, it must furthermore be capable of processing in parallel different coloured sub-frames, 1 per band. It can include one or several column driver circuits which are then driven synchronously. It can be of the integrated type or external to the display.

Alternatively, there can be n line driver circuits, one line driver circuit per band, which can be integrated or external to the display, and which are controlled non-synchronously. This makes it possible to address the n bands in a desynchronised manner, i.e. it is possible to thus address n rows in parallel, 1 row per band, but non-synchronously. Such an alternative makes it possible more preferably to avoid a simultaneous rupture in lighting across the n bands. In this case, it must also be allowed for that the outputs of column control circuit 2 not be all latched at the same time, but latched relatively to their respective band, and provide lighting sequences that are driven in an adapted manner.

The regrouping mode into n bands has just been explained (and illustrated) in an example where n=3. But it applies in general with n greater than or equal to 2. In all cases, each of the n groups GB1 to GBn of the screen receives the 3 colours. The number n of groups is defined in practice by the minimum time for refreshing the active matrix as well as by the time needed to stabilise the liquid crystal.

Another embodiment of groups of rows of pixels according to the invention is illustrated in FIG. 4.

The n groups of rows GB1, GB2, GB3 each comprise k=N/n rows of rank 1 to k. They are formed such that the n rows selected at the same time by the same output of the line driver 1 are n successive rows of the matrix. The groups of rows are interlaced in this case. In the example, the successive rows of pixels are selected by the same line selection signal SelR₁. The first row is the row of rank 1 Row₁(GB1) of the group GB1, associated with the selection line r₁ of the display; the second row is the row of rank 1 Row₁(GB2) of the group GB2, associated with the selection line r₂ of the display; the third row is the row of rank 1 Row₁(GB3) of the group GB3, associated with the selection line r₃ of the display. These three rows Row₁(GB1), Row₁(GB2) and Row₁(GB3) are selected simultaneously, in the example by the selection signal SelR₁ supplied by the line driver 1 and applied on the three selection lines r₁, r₂, r₃.

Such an embodiment is more specifically advantageous if the N rows of the display are divided into two groups GB1 and GB2. In fact, in this case, it is possible to devise the design of the active matrix such that the same row selection line is physically common to two successive rows of pixels.

A corresponding arrangement is illustrated in FIG. 5.

Two successive rows of the display belong in one case to the group GB1 and the other to the group GB2. They have the same row selection line in common. For example, r₁ is common to Row₁(GB1) and Row₁(GB2). Each of these two rows has a corresponding respective column wire, c_{1,1} for the pixel at the intersection of Row₁(GB1) and COL₁ and c_{1,2} for the pixel at the intersection of Row₁(GB2) and COL₁.

If p and p′ refer respectively to the pixels of the group GB1 and GB2, each transistor of pixel p of the first group is arranged in the top left corner formed by the column wires and the selection line; each pixel p′ of the second group is arranged in the bottom left corner formed by the two column wires and the selection line.

In this way, by reducing the number of selection lines, the number of line/column intersections on the active matrix is reduced. Therefore, the risk of line/column short-circuits is reduced. The productivity is thus improved.

In addition, arrangements as illustrated in FIGS. 4 and 5 make it possible with a simple design to obtain a single line driver output for several synchronous lines, while a structure as illustrated in FIG. 2, wherein 3 synchronous lines are driven with a single line driver output induces in practice a large number of intersections and uses up a large amount of peripheral space.

In another alternative embodiment illustrated in FIG. 6a, particularly applicable if the rows of pixels of the display are distributed into n=2 groups, a top column driver and a bottom column driver are used: half of the display is addressed by the top and the other half by the bottom. In this way, the two column wires of each pixel column extend from each other, one being on the top part and the other on the bottom part: they are no longer in parallel. The production reliability of such a matrix is improved significantly by reducing the risks of short-circuits between the column wires. In this case, there is physically only one column wire on the active matrix s opposite each row per pixel column, instead of n parallel wires: the effective surface area (Open aperture Ratio) is not degraded with respect to a display according to FIG. 5: the surface area of a structure with 2 columns per pixel reduces the effective surface area of the pixel significantly (typically of the order of 5% to 10% less effective surface area on the structure in FIG. 5 with respect to FIG. 6a for a 300 μm pixel).

This alternative embodiment may be combined with that described with reference to FIG. 5. This is illustrated in FIG. 6b: in this case, there are n=3 groups. In a top part of the display, the rows are divided into two groups, two successive rows belonging to two separate groups and sharing the same row selection line. There are three column wires per pixel column: two parallel column wires on the top part, for each pixel column, for example the wires c_{1,1} and c_{1,2} for the column COL₁. These column wires are controlled by a column driver 2a, at the top of the display.

The rows at the bottom of the display form the third group GB3. This part comprises the third column wire, for example the wire c_{1,3} of the column COL₁. These column wires are controlled by a column driver 2b at the bottom of the display.

Other combinations are possible, according to requirements and expected performances. In particular, it is possible to have the same arrangement at the bottom as at the top: in this case, there are four groups of rows, two at the top, controlled by the column driver 2a and two at the bottom controlled by the column driver 2b.

FIGS. 7, 8a and 8b, 9a and 9b, illustrate schematically how to produce a corresponding active matrix topology, and in particular, the design of the column wires and their contacts with the transistors.

FIG. 7 illustrates a possible embodiment on an active matrix, of the n column wires per pixel column, in an arrangement of n strips according to the invention. In the example, n=3. Therefore, there are three strips GB1, GB2, GB3. These bands or strips may be lit according to separate coloured sequences. In the example, for a given sub-frame, the strip GB1 is lit in red (LED-R), and its pixels receive the data Data-R from the red sub-frame, the strip GB2 is lit in green (LED-G), and its pixels receive the data Data-G from the green sub-frame, and the strip GB3 is lit in blue (LED-B), and its pixels receive the data Data-B from the blue sub-frame.

For simplification purposes, the selection lines are not shown.

To apply the video data of the sub-frames in question on the pixels of the different n strips according to the invention, there are n column wires per pixel column.

In the example illustrated in FIG. 7, in this way, for the pixel column COL₁, there are n=3 column wires c_{1,1}, c_{1,2}, C_{1,3}.

If the display comprises m pixel columns, the column driver must thus drive n=3 times m column wires. It should be noted that the term “column driver” covers the column wire driving function, in order to display video data according to the addressing sequence, independently from its hardware composition. In this respect, it should be noted that the column driver may be of the integrated type, or external to the display. In practice, it may comprise one or more circuits controlled synchronously.

Let us consider the column COL₁. The column wires c_{1,1}, c_{1,2}, c_{1,3} are connected respectively the first to the pixels (and more specifically to their transistors) of the rows of the first strip GB1, the second to the pixels of the rows of the second strip GB2 and the third to the pixels of the rows of the third strip GB3. The design of the column wires is such that each column wire associated with a strip does not extend beyond this strip. The number of intersections with the lines and columns is reduced, along with the length of opposite wires, which makes it possible to reduce risks of short-circuits.

In a more detailed manner, this design is such that, on the first strip GB1, there are n=3 column wires c_{1,1}, c_{1,2}, c_{1,3} in parallel for each pixel column. On the second strip, there are n−1=2 column wires c_{1,2}, c_{1,3}. The design of the wire c_{1,2} on the second strip is such that said wire is positioned in the extension of the axis of the wire c_{1,1}. In this way, the pixels in the strip GB2 have substantially the same coupling capacity with the column wire as those of the strip GB1. On the third strip, there is n−2=1 column wire c_{1,3}. The design of the wire c_{1,3} is such that an arm of this wire is positioned in the extension of the axis of the wire c_{1,1}. In this way, the pixels in the strip GB3 have a coupling capacity with the column wire as close as possible to that of the pixels of the strips GB1 and GB2.

Such an embodiment makes it possible to offer a compromise between the reduction of risks of short-circuits between the column wires in the creation of the connections with the pixels, and a harmonisation of the coupling capacities between the different strips, so as to ensure a display behaviour that is as uniform as possible on the display.

Another embodiment is illustrated in FIG. 8a. In the case of the column COL₁, this embodiment is such that the three column wires c_{1,1}, c_{1,2}, c_{1,3} of this column are arranged in parallel throughout the height of the display: they are present on all the strips. Uniformity of the pixel-column coupling throughout the display is ensured.

However, on the other hand, this has an impact on the production output of the active matrices, as the risk of short-circuits between the columns is increased. In FIG. 8a, the respective connections j₁, j₂, j₃ between the column wires c_{1,1}, c_{1,2}, c_{1,3}, and the pixels are all on the same side, in the example illustrated, on the left. The first strip contains the connections j₁, the second strip the connections j₂ and the third strip the connections j₃.

This embodiment also applies if the groups of rows according to the invention are interlaced. In fact, in this alternative embodiment of grouping according to the invention, it is provided that the same selection signal controls n successive rows of the display. If n=3, there are three successive rows of pixels controlled by the same line selection signal. In the case of the pixel column COL₁, the pixel corresponding to the second line is connected by the connection j₁ to the first column wire c_{1,1}. The pixel corresponding to the second line is connected by the connection j₂ to the second column wire c_{1,2}. The pixel corresponding to the third line is connected by the connection j₃ to the third column wire c_{1,3}. In the example, the connections of a pixel to the corresponding column wire are all on the same side, in the example, on the left.

FIGS. 9a and 9b illustrate an alternative embodiment of FIGS. 8a and 8b wherein the pixels are connected sometimes on the right, sometimes on the left, the corresponding column wire being located in this case either on the right, or on the left.

In the example illustrated in FIG. 9a, corresponding to an arrangement in strips according to the invention where n=3, the pixels of the strips GB1 and GB2 are connected on the left and those of the strip GB3 are connected on the right.

In the example illustrated in FIG. 9b, corresponding to a division of the rows into interlaced groups, the pixels of two successive rows are connected on the left and the pixels of the third row are connected on the right. In the case of the pixel column COL₁, the pixels of the first and second rows are connected on the left to their respective column wire, c_{1,1}, c_{1,2}. The pixel of the third row is connected on the right to the corresponding column wire c_{1,3}, arranged to the right of the pixel column.

This alternative embodiment is particularly applicable to an arrangement with two groups according to the invention, with two column wires per pixel column and a common selection line for two successive pixel rows as illustrated in FIG. 5 already described.

It also applies to an arrangement in groups of interlaced rows, or an arrangement in bands or strips according to the invention.

Such an embodiment makes it possible to reduce the intersections with the columns and therefore the risks of short-circuits. However, it is difficult in terms of design to maintain substantially the same opening ratio everywhere, which is due to the differences in the designs for the pixels connected on the left and those connected on the right.

1-20. (canceled)

21. A matrix display with sequential display of colors, of active matrix-type, comprising:
pixels arranged according to N rows and m columns, wherein the N rows are distributed into n groups, and each pixel column includes n column conductors, allowing for a write-selection of pixels of n rows in parallel, one row per group.

22. A matrix display according to claim 21, wherein the n write-selected rows are selected simultaneously.

23. A matrix display according to claim 21, wherein the n rows of a group are n successive rows of the display, so that the display is organized into n bands of N/n successive rows.

24. A matrix display according to claim 23, further comprising a light source configured to light each of the bands, according to a different color sequence, to provide a back-light.

25. A matrix display according to claim 23, comprising two bands, an upper band with associated column conductors controlled by a column driver arranged in the upper part of the display, and a lower band with associated column conductors controlled by a column driver arranged in the lower part of the display.

26. A matrix display according to claim 23, wherein the column conductors associated with a band do not extend beyond the band.

27. A matrix display according to claim 21, wherein the n write-selected rows are n successive rows of the display, selected simultaneously.

28. A matrix display according to claim 27, wherein the two successive rows, one belonging to a first group and the other belonging to a second group, are connected to a single row selection line.

29. A matrix display according to claim 28, wherein n is equal to 2.

30. A matrix display according to claim 21, wherein in a first part of the display, the rows are controlled by a first column driver and organized so that two successive rows, one belonging to a first group and the other belonging to a second group, are connected to a single row selection line.

31. A matrix display according to claim 30, wherein in a second part of the display, the rows are controlled by a second column driver.

32. A matrix display according to claim 31, wherein in the second part, the rows form a third group.

33. A matrix display according to claim 31, wherein in the second part, the rows are organized so that two successive rows belonging to two different groups are connected to a single row selection line.

34. A method for addressing a matrix display, of active matrix-type, in a sequential color display mode, the display including pixels arranged as a matrix in rows and columns, the method comprising:
selecting n rows of pixels in parallel; and
applying video data corresponding to the n rows by n column conductors for each pixel column, each of the n conductors providing video data on a pixel of one of the n rows.

35. An addressing method according to claim 34, wherein the n rows are selected simultaneously and receive the same selection signal provided by a selection line control circuit.

36. Addressing method according to claim 34, wherein the n selected rows each receive a selection signal of a selection line control circuit.

37. Addressing method according to claim 36, wherein the n rows are selected simultaneously, receiving a selection signal transmitted synchronously for said n rows.

38. Addressing method according to claim 34, the display including N rows, wherein the n selected rows each belong to a different group of N/n successive rows of the display.

39. Addressing method according to claim 35, the display including N rows, wherein the n selected rows each belong to a different group of N/n successive rows of the display.

40. Addressing method according to claim 36, the display including N rows, wherein the n selected rows each belong to a different group of N/n successive rows of the display.

41. Addressing method according to claim 37, the display including N rows, wherein the n selected rows each belong to a different group of N/n successive rows of the display.

42. An addressing method according to claim 34, the display including N rows, wherein the n selected rows each belong to a different group of N/n successive rows of the display and wherein each of the groups is lit according to a different color sequence and the video data applied for each pixel column on the column conductor associated with a group corresponds to the color sequence.

43. An addressing method according to claim 35, the display including N rows, wherein the n selected rows each belong to a different group of N/n successive rows of the display and wherein each of the groups is lit according to a different color sequence and the video data applied for each pixel column on the column conductor associated with a group corresponds to the color sequence.

44. An addressing method according to claim 36, the display including N rows, wherein the n selected rows each belong to a different group of N/n successive rows of the display and wherein each of the groups is lit according to a different color sequence and the video data applied for each pixel column on the column conductor associated with a group corresponds to the color sequence.

45. An addressing method according to claim 37, the display including N rows, wherein the n selected rows each belong to a different group of N/n successive rows of the display and wherein each of the groups is lit according to a different color sequence and the video data applied for each pixel column on the column conductor associated with a group corresponds to the color sequence.

46. An addressing method according to claim 35, wherein the n selected rows are n successive rows of the display, selected simultaneously.

47. An addressing method according to claim 37, wherein the n selected rows are n successive rows of the display, selected simultaneously.
